(19) United States
(12) Patent Application Publication
(10) Pub. No.: US 2025/0024277 A1
(43) Pub. Date: Jan. 16, 2025

(54) METHOD FOR AUTOMATICALLY RESTORING FUNCTIONALITY IN A RESIDENTIAL GATEWAY

(71) Applicant: SAGEMCOM BROADBAND SAS, Bois-Colombes (FR)

(72) Inventor: Nicolas KORBER, Bois-Colombes (FR)

(73) Assignee: SAGEMCOM BROADBAND SAS, Bois-Colombes (FR)

(21) Appl. No.: 18/759,034

(22) Filed: Jun. 28, 2024

(30) Foreign Application Priority Data
Jul. 11, 2023 (FR) 2307444

(51) Int. Cl. H04W 24/04; H04L 41/0654

(52) U.S. Cl. CPC H04W 24/04; H04L 41/0654

(57) ABSTRACT

A residential gateway that includes a modem for connecting to a mobile network via which a broadband network is accessible and a broadband controller for connecting to the broadband network. To remedy a malfunctioning of the broadband controller, the residential gateway is configured for: receiving, by the modem, by means of a user plane of the mobile network, an alert message instructing applying a restoration strategy aimed at restoring the functionality of the broadband controller; applying, by the modem, the restoration strategy with regard to the broadband controller.

### TECHNICAL FIELD

The present invention relates to a method for automatically restoring functionality in a residential gateway offering broadband-access services via a fixed wireless access (FWA).

### PRIOR ART

Fixed wireless access (FWA) technologies enable network operators to provide ultrafast broadband access without having to deploy cable or fibre network structures, relying on the latest-generation mobile network technologies (4G, 5G, etc). This makes it possible in particular to provide broadband access services in suburban and rural geographical areas where deploying optical fibre may present high complexity of deployment and maintenance.

Despite the benefits provided by these fixed wireless access technologies, the fact remains that some malfunctionings at the present time require human intervention.

For example, in the case where a residential gateway no longer communicates with an auto configuration server ACS, the control plane link is broken, it is generally considered that the latter cannot be restored remotely if the fault stems from the broadband access part of the residential gateway. Manual local intervention is generally needed to remedy this situation: restarting of the residential gateway, restoration of factory settings, etc. This requires a technician call with the end user, or even for a technician to work at the home of the end user.

When attempts at manual repair (restarting, restoration of factory settings, configuration by graphical interface of the residential gateway accessible via a LAN (“Local Area Network”) interface) fail, if the fault is software rather than hardware it is potentially possible to restore the broadband access functionality of the residential gateway by injecting particular commands therein. Unfortunately, this type of operation is not possible remotely if the control plane link is broken.

It is desirable to provide a solution that makes it possible to deal automatically with this type of malfunction, without human intervention.

### DISCLOSURE

A method is proposed here for restoring a functionality of a broadband controller of a residential gateway, the residential gateway comprising electronic circuitry implementing a modem for connecting the residential gateway to a mobile network via which a broadband network is accessible, the electronic circuitry furthermore implementing the broadband controller to connect the residential gateway to the broadband network. To remedy a malfunctioning of the broadband controller, the method comprises: receiving, by the modem, by means of a user plane of the mobile network, an alert message instructing applying a restoration strategy aimed at restoring the functionality of the broadband controller; and applying, by the modem, the restoration strategy with regard to the broadband controller.

Thus the functionality of a broadband controller of a residential gateway is restored automatically, without having recourse to human intervention.

According to a particular embodiment, the method furthermore comprises: transmitting, by the modem, by means of the user plane of the mobile network, a confirmation message confirming that the restoration strategy has been applied.

According to a particular embodiment, the confirmation message takes the form of a service SMS message intended for a dedicated telephone number.

According to a particular embodiment, the alert message takes the form of an SMS message.

According to a particular embodiment, the alert message contains information representing the restoration strategy to be applied from a predefined set of restoration strategies.

According to a particular embodiment, the alert message contains a description of a command or of a set of commands to be applied in the restoration strategy.

According to a particular embodiment, when the restoration strategy consists of rebooting the residential gateway, the modem records in non-volatile memory information indicating that the confirmation message has to be transmitted after rebooting the residential gateway and re-establishing the user plane of the mobile network.

A computer program is also proposed here, comprising program code instructions causing an implementation of the method disclosed above in any one of its embodiments, when said instructions are executed by a processor. An information storage medium is also proposed here, storing such program code instructions.

A residential gateway is also proposed, comprising electronic circuitry configured for residential Gateway comprising electronic circuitry configured to implement a modem for connecting the residential gateway to a mobile network via which a broadband network is accessible, and a broadband controller for connecting the residential gateway to the broadband network. To remedy a malfunctioning of the broadband controller, the electronic circuitry is configured for: receiving, by the modem, by means of a user plane of the mobile network, an alert message instructing applying a restoration strategy aimed at restoring the functionality of the broadband controller; applying, by the modem, the restoration strategy with regard to the broadband controller; and transmitting, by the modem, by means of the user plane of the mobile network, a confirmation message confirming that the restoration strategy has been applied.

### BRIEF DESCRIPTION OF THE DRAWINGS

The features of the invention mentioned above, as well as others, will emerge more clearly from the reading of the following description of at least one example embodiment, said description being made in relation to the accompanying drawings, among which:

FIG. 1 illustrates schematically a communication system;

FIG. 2 illustrates schematically an internal interconnection of a residential gateway of the communication system;

FIG. 3 illustrates schematically a hardware arrangement that can be used in the residential gateway;

FIG. 4 illustrates schematically logic communication pathways in the communication system;

FIG. 5 illustrates schematically an algorithm for automatically restoring functionality of the residential gateway, in one embodiment; and

FIG. 6 illustrates schematically exchanges occurring in the communication system in the context of an automatic restoration of functionality of the residential gateway, in one embodiment.

### DETAILED DISCLOSURE OF EMBODIMENTS

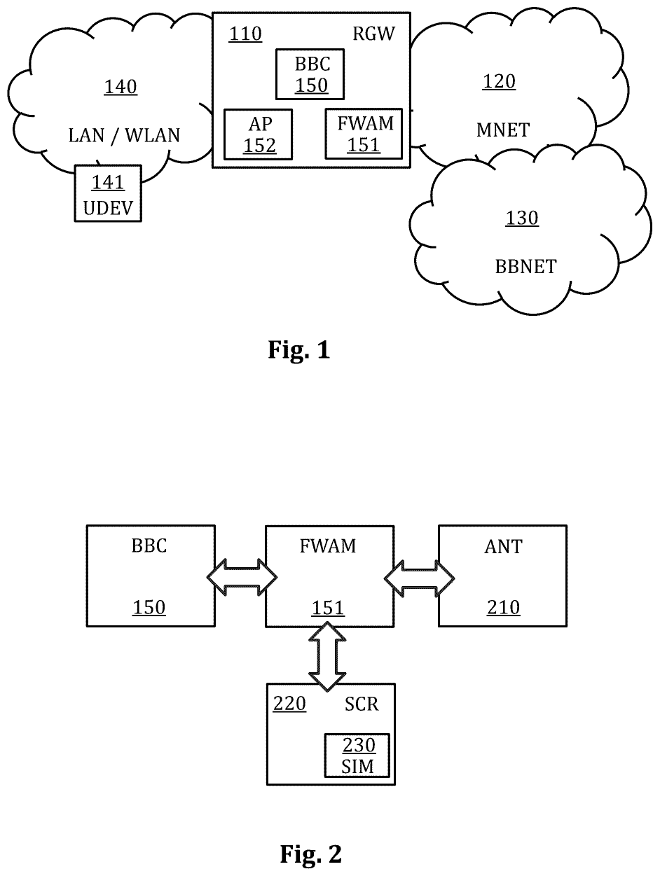

FIG. 1 illustrates schematically a communication system comprising a residential gateway RGW 110.

The residential gateway RGW 110 implements a fixed wireless access (FWA) technology.

The residential gateway RGW 110 is considered to be equipment of the CPE (“Customer-Premises Equipment”) type in FWA technologies.

The residential gateway GW 110 is able to provide a set of services to an end user, including a service of access to a broadband network, also referred to as high-speed network or fixed-access network, BBNET 130 by means of a mobile network MNET 120.

The terms “broadband network”, “high-speed network” and “fixed-access network” are used equivalently.

The residential gateway RGW 110 comprises a modem FWAM 151 for connecting the residential gateway RGW 110 to the mobile network MNET 120 and a broadband controller BBC 150 (or broadband-access controller) for connecting the residential gateway RGW 110 to the broadband network BBNET 130. The term “broadband controller” also means a controller of access to the broadband network, or equivalently a controller of access to the high-speed network.

The residential gateway RGW 110 preferentially comprises a LAN interface manager, such as an access point AP 152 for establishing a network of the WLAN (“Wireless LAN”) type, such as for example a Wi-Fi network. The user can thus benefit from the services offered by the broadband network BBNET 130 by means of a terminal or user device UDEV 141 (such as a computer, an electronic tablet, a smartphone, a TV set-top box etc).

FIG. 2 illustrates schematically an internal interconnection of the residential gateway RGW 110.

The modem FWAM 151 is interconnected with the controller BBC 150.

The modem FWAM 151 is interconnected with a SIM (“Subscriber Identity Module) card reader SCR 220 in which a SIM card 230 can be placed. In a variant, the modem FWAM 151 can be interconnected with a chip of the eSIM type soldered to an electronic card of the residential gateway RGW 110 or integrated by software and/or hardware in the residential gateway RGW 110. The modem FWAM 151 implements a user-equipment UE function with respect to the mobile network MNET 120, in accordance with the technology employed in the mobile telephony network standards.

The modem FWAM 151 is interconnected with an antenna system ANT 210 enabling the modem FWAM 151 to communicate with equipment of the mobile network MNET 120.

The interconnections in the residential gateway RGW 110 can be made by means of communication buses, for example of the PCI (“Peripheral Component Interconnect”) or USB (“Universal Serial Bus”) type

To enable the residential gateway RGW 110 to benefit from the services of the mobile network MNET 120, the modem FWAM 151 implements an authentication of the SIM card 230, or of the eSIM chip, with the mobile network MNET 120, for example by exchanging with an authentication centre AuC of the mobile network MNET 120. Following this prior authentication of the SIM card 230, or the chip eSIM, the modem FWAM 151 holds an encryption key enabling communications to be made by and with the residential gateway RGW 110 in the mobile network MNET 120. The residential gateway RGW 110 can thus benefit from the services of the mobile network MNET 120. An operational communication link is then established between the residential gateway RGW 110 and the core of the mobile network MNET 120, and another authentication can then be implemented through this communication link to enable the residential gateway RGW 110 to implement another authentication with the broadband network BBNET 130 in order to be able to benefit from the services of the broadband network BBNET 130.

The modem FWAM 151 and the controller BBC 150 operate independently of each other. Each has its own processing/computing and memory resources. The modem FWAM 151 and the controller BBC 150 can be implemented by software on one and the same processor and be interconnected by a software bus. The modem FWAM 151 and the controller BBC 150 can in a variant be implemented on separate processors and be interconnected by a hardware bus.

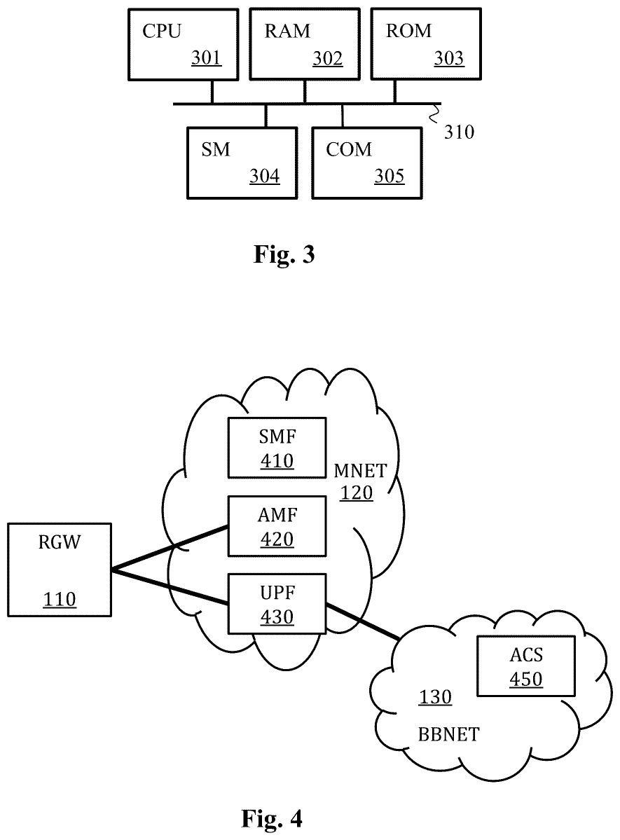

FIG. 3 illustrates schematically a hardware arrangement that can be used in the residential gateway RGW 110, more particularly for implementing the controller BBC 150 and/or the modem FWAM 151.

The hardware arrangement presented comprises, connected by a communication bus 310: a processor or CPU (“central processing unit”) 301; a random access memory (RAM) 302; a non-volatile memory, for example of the ROM (read only memory) 303 or EEPROM (“electrically-erasable programmable read-only memory”) type, or of the flash type; a storage unit, such as a storage medium SM 304, for example a hard disk HDD, or a storage medium reader, such as an SD (Secure Digital) card reader; and an interface manager COM 305.

The interface manager COM 305 enables the hardware arrangement presented to interact with other elements of the residential gateway RGW 110, such as for example the SIM card reader SCR 220 or the antenna system ANT 210 or the access point AP 152.

The processor or CPU 301 is capable of executing instructions loaded in the random access memory 302, in particular from the non-volatile memory 303 or from the storage medium SM (such as an SD card) 304. When the hardware arrangement presented is powered up, the processor or CPU 301 is thus capable of reading instructions from the random access memory RAM 302 and executing them. These instructions form a computer program causing in particular the implementation, by the processor or CPU 301, of the steps and behaviours described here in relation to the modem FWAM 151 and the controller BBC 150, or more generally of the residential gateway RGW 110.

All or some of the steps and behaviours described here can thus be implemented in software form by executing a set of instructions by a programmable machine, for example a processor of the DSP (“digital signal processor”) type, or a microcontroller, or be implemented in hardware form by a machine or a dedicated electronic component (chip) or a dedicated set of electronic components (chipset), for example an FPGA (field-programmable gate array) or ASIC (application-specific integrated circuit) component. In general terms, the modem FWAM 151 and the controller BBC 150, and more generally the residential gateway RGW 110, comprise electronic circuitry adapted and configured to implement the steps and behaviours described here.

FIG. 4 illustrates schematically logic communication pathways in the communication system;

By way of illustration, the mobile network MNET 120 conforms to the 5G mobile telephony standards.

The mobile network MNET 120 comprises, apart from a radio access network RAN part, and a core network part that includes various items of equipment and/or functions including an SMF (“Session Management Function”) entity 410, an AMF (“Access and Mobility management Function”) entity 420 and a UPF (“User Plane Function”) entity 430.

As its name indicates, the UPF entity manages the user plane, also referred to as data plane, i.e. the transport of the user traffic. A user-plane link thus connects the residential gateway RGW 110 and the UPF entity 430. This user-plane link is supported by an interface typically denoted NG-u between the radio access network part and the core network part.

Thus, with regard to the residential gateway RGW 110, the exchanges made between the residential gateway RGW 110 and the broadband network BBNET 130 pass through the UPF entity 430 in the mobile network MNET 120. In other words, the exchanges via the mobile network MNET 120 that involve the controller BBC 150 pass through the user plane link with the UPF entity 430, whether for control-plane message exchanges or user-plane data exchanges.

Thus the controller BBC 150 is in communication with the broadband network BBNET 130. To exchange with an auto configuration server ACS 450 involved in the control plane of the broadband network BBNET 130, the controller BBC 150 typically implements a daemon in accordance with the protocol TR-069 (“CPE WAN Management Protocol”, published by the Broadband Forum).

The user data exchanges that involve the modem FWAM 151, such as exchanges by SMS (“Short Message Service”) messages, pass through the user plane link with the UPF entity 430.

To enable user plane links to be established in the mobile network MNET 120, the SMF entity 410 and the AMF entity 420 cooperate in implementing the control plane of the mobile network MNET 120. A user-plane link thus connects the residential gateway RGW 110 and the AMF entity 420. This control-plane link is supported by an interface typically denoted NG-c between the radio access network part and the core network part.

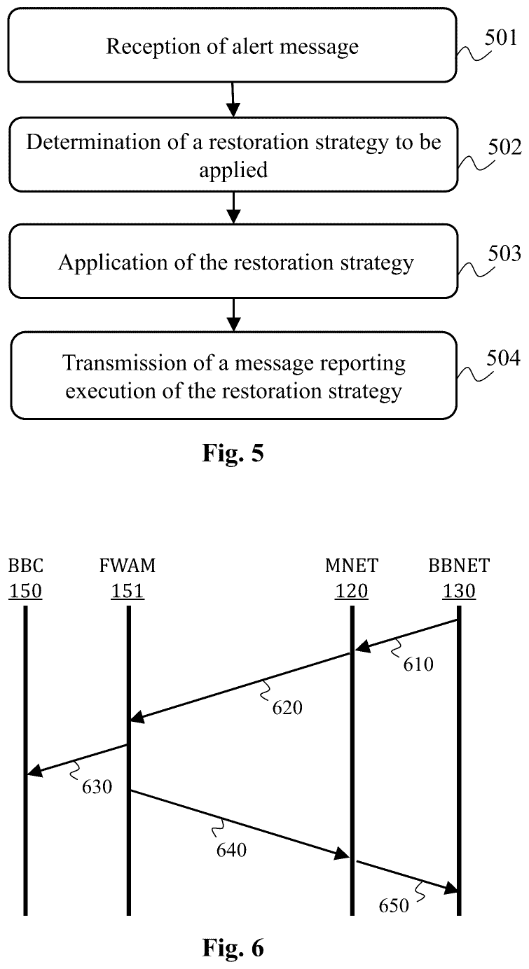

FIG. 5 illustrates schematically an algorithm for automatically restoring functionality of the residential gateway RGW 110, in one embodiment. The algorithm in FIG. 5 aims to make the residential gateway RGW 110 fully operational following a recognised fault in the controller BBC 150. As detailed below in relation to FIG. 6, the fault in the controller BBC 150 is recognised from the broadband network BBNET 130, for example by the auto configuration server ACS 450.

In a step 501, the modem FWAM 151 receives an alert message by means of the user plane of the mobile network MNET 120. The alert message represents a recognised fault in the controller BBC 150.

In a particular embodiment, this alert message takes the form of an SMS message. Since this SMS message is not intended to be read by the user, the residential gateway RGW 110 deletes it without storing it in the SIM card or in memory of the modem FWAM 151. In another example, this message is received and processed by a secure element of the modem FWAM 151, an element to which the end user does not have access. Service SMS message or silent SMS message is spoken of.

Preferentially, the alert message contains information representing a restoration strategy to be applied by the modem FWAM 151 with regard to the controller BBC 150 (from a predefined set of restoration strategies).

In a particular embodiment, the alert message contains a description of a command or of a set of commands to be applied by the modem FWAM 151 with regard to the controller BBC 150 in the restoration strategy.

In a step 502, the modem FWAM 151 determines a restoration strategy to be applied to deal with the recognised fault in the controller BBC 150. The restoration strategy to be applied can be deduced from the alert message received. The restoration strategy to be applied can also be deduced by performing a few tests on the reaction of the controller BBC 150 to stimuli generated by the modem FWAM 151. This can make it possible to determine to what extent the controller BBC 150 is inoperative, or which functionality of the controller BBC 150 is to be restored, and to decide accordingly on the restoration strategy to be applied.

The restoration strategy may consist of rebooting the residential gateway RGW 110, for example on request in the alert message or because the modem FWAM 151 has noted that the controller BBC 150 is completely inoperative. In this case, the modem FWAM 151 records in non-volatile memory information indicating that it has to repeat the algorithm in FIG. 5 at a step 504 when the residential gateway RGW 110 has restarted and when the communication link with the mobile network MNET 120 is once again operational (re-establishment of the user plane of the mobile network MNET 120).

The restoration strategy may consist of restarting only the controller BBC 150, for example on request in the alert message or because the modem FWAM 151 has noted that the controller BBC 150 is inoperative in some of a set of unit tests.

The restoration strategy may consist of restoring factory settings of the BBC controller 150, example on request in the alert message.

The restoration strategy may consist of executing a command or a set of commands as predefined in the alert message.

The objective of the restoration strategy is to restore a functionality of the controller BBC 150 and thus to make the BBC controller 150 once again operational and able to be in communication with the broadband network BBNET 130, so as to enable the residential gateway RGW 110 to benefit from the services of the broadband network BBNET 130.

Then, in the step 504, the modem FWAM 151 transmits, in response to the alert message received at the step 501, a message confirming application of the restoration strategy. In a particular embodiment, the modem FWAM 151 checks what result applying the restoration strategy has given, and includes information representing said result in the response message.

In to a particular embodiment, this alert message takes the form of a service SMS message intended for a dedicated telephone number. Since this service SMS message is not intended to be read by the user, the residential gateway RGW 110 deletes it without storing it in the SIM card or in memory of the modem FWAM 151.

FIG. 6 illustrates schematically exchanges occurring in the communication system in the context of an automatic restoration of functionality of the residential gateway RGW 110, in one embodiment.

Prior to the exchanges in FIG. 6, an item of equipment in the broadband network BBNET 130 detects a malfunction in the controller BBC 150 of the residential gateway RGW 110. For example, in the control plane of the broadband network BBNET 130, the auto configuration server ACS 450 detects a loss of connection with the controller BBC 150. For example, in application of the protocol TR-069, the controller BBC 150 is supposed to periodically contact the auto configuration server ACS 450. If such is not the case, the auto configuration server ACS 450 detects the loss of connection with the controller BBC 150. A loss of connection with the controller BBC 150 may also be detected following a predefined number of unsuccessful attempts at contacting the controller BBC 150.

In a step 610, following the detection of the malfunctioning of the controller BBC 150 of the residential gateway RGW 110, an item of equipment in the broadband network BBNET 130 sends to an item of equipment in the mobile network MNET 120 an alert message to be sent to the modem FWA 151 of the residential gateway RGW 110. The item of equipment in the broadband network BBNET 130 informs the item of equipment in the mobile network MNET 120 in question about the identity of the residential gateway RGW 110, for example by its MAC (“Medium Access Control”) address or its IMEI (“International Mobile Equipment Identity”). The item of equipment in the broadband network BBNET 130 that sends the alert message to the item of equipment in the mobile network MNET 120 in general forms part of an operational support system OSS of the broadband network BBNET 130. This message can be sent via an event-driven notification of the “event log” or “web socket” type, or be transported by an MQTT (“Message Queueing Telemetry Transport”) or http(s) (“HyperText Transfer Protocol (Secure)”), etc protocol.

In a step 620, the item of equipment in the mobile network MNET 120 transmits the alert message to the modem FWA 151 of the residential gateway RGW 110. As already indicated, in a particular embodiment, this alert message takes the form of a service SMS message. The item of equipment in the mobile network MNET 120 in question is then an SMSC (“Short Message Service Centre”) messaging centre.

In a step 630, the modem FWA 151 applies a restoration strategy, as already explained in relation to FIG. 5.

Once the restoration strategy has been applied, in a step 640, the modem FWAM 151 sends, in response to the alert message, a message confirming application of the restoration strategy. As already indicated, in a particular embodiment, this alert message takes the form of a service SMS message.

And, in a step 650, the item of equipment in the mobile network MNET 120 that received the message confirming application of the restoration strategy informs an item of equipment of the broadband network BBNET 130 of this, typically the auto configuration server ACS 450. It is thus possible to automatically re-establish the communication between the broadband network BBNET 130 and the controller BBC 150 of the residential gateway RGW 110, without therefore having recourse to human intervention.

In a particular embodiment, in the broadband network BBNET 130, the alert message and the confirmation message may pass through an intermediate server, referred to as PNM (“Pro-active Network Management”) server.

In a particular embodiment, the modem FWA 110 exchanges directly with the broadband network BBNET 130 in the context of applying the restoration strategy.

1. A method for restoring a functionality of a broadband controller of a residential gateway, the residential gateway comprising electronic circuitry implementing a modem for connecting the residential gateway to a mobile network via which a broadband network is accessible, the electronic circuitry furthermore implementing the broadband controller to connect the residential gateway to the broadband network,
wherein, to remedy a malfunctioning of the broadband controller, the method comprises:
receiving, by the modem, by means of a user plane of the mobile network, an alert message instructing applying a restoration strategy aimed at restoring the functionality of the broadband controller; and
applying, by the modem, the restoration strategy with regard to the broadband controller.

2. The method according to claim 1, furthermore comprising:
transmitting, by the modem, by means of the user plane of the mobile network, a confirmation message confirming that the restoration strategy has been applied.

3. The method according to claim 2, wherein the confirmation message takes the form of a service SMS message intended for a dedicated telephone number.

4. The method according to claim 1, wherein the alert message takes the form of an SMS message.

5. The method according to claim 1, wherein the alert message contains information representing the restoration strategy to be applied from a predefined set of restoration strategies.

6. The method according to claim 1, wherein the alert message contains a description of a command or of a set of commands to be applied in the restoration strategy.

7. The method according to claim 1, wherein, when the restoration strategy consists of rebooting the residential gateway, the modem records in non-volatile memory information indicating that the confirmation message has to be transmitted after the residential gateway is rebooted and the user plane of the mobile network is re-established.

8. A residential gateway comprising electronic circuitry configured to implement a modem for connecting the residential gateway to a mobile network via which a broadband network is accessible, and a broadband controller for connecting the residential gateway to the broadband network, wherein, to remedy a malfunctioning of the broadband controller, the electronic circuitry is configured for:
receiving, by the modem, by means of a user plane of the mobile network, an alert message instructing applying a restoration strategy aimed at restoring the functionality of the broadband controller;
applying, by the modem, the restoration strategy with regard to the broadband controller.

9. (canceled)

10. A non-transitory information storage medium storing program code instructions causing an implementation of the method according to claim 1, when said instructions are read and executed by a processor.
